(19) United States
(12) Patent Application Publication
(10) Pub. No.: US 2005/0253003 A1
(43) Pub. Date: Nov. 17, 2005

(54) Off center hammermill

(75) Inventor: Carl Bonner, Caldwell, ID (US)

Correspondence Address: ROBERT L. SHAVER, DYKAS, SHAVER & NIPPER, LLP, P.O. BOX 877, BOISE, ID, 83701-0877, US

(73) Assignee: Diamond Z Manufacturing, Caldwell, ID (US)

(21) Appl. No.: 10/846,371

(22) Filed: May 14, 2004

(51) Int. Cl. B02C 13/284

(52) U.S. Cl. 241/73

(57) ABSTRACT

A grinding device with a hammermill which defines a grinding zone. The grinding zone is surrounded by a screen cylinder, and a screen which takes up part of the region of the screen cylinder. The axis of the screen cylinder is not concentric with the axis of rotation of the hammermill. This allows the screen to have a large gap near the cutter bar and at the entry side than at other areas between the screen and the hammermill.

### BACKGROUND OF THE INVENTION

1. Field of the Invention.

The present invention generally relates to hammermills, and more particularly to horizontally fed hammermills.

2. Background Information.

Hammermills are typically used to grind large material into smaller pieces. One popular form of a hammermill is that in which feed material is fed into the mill on a generally horizontal feed chain. The material to be ground is fed into the hammermill over a cutter bar and the hammermill rotates to break material against the cutter bar. A horizontal hammermill includes a horizontally oriented hammermill shaft, to which are attached a number of hammers. The hammers typically have replaceable tips mounted at their periphery, which actually strike the material to be ground. Material is fed into the hammermill on a feed chain, which can also be a belt or other feed mechanism. A feed roller is typically present, which presses down against the material being fed into the hammermill, and keeps it from bouncing back. The feed roller is also part of a shroud, which raises and lowers with the feed roller, and prevents debris from flying out of the hammermill as it is in operation. In a horizontal hammermill, a screen is located on the underside of the hammermill, through which material may exit from the grinding zone. The screen has holes, and depending on the size of the holes, different sizes of pieces exit from the hammermill. If a piece is too large to go through a hole of the screen, it passes around the hammermill one more time and is ground to a smaller size.

A problem with existing hammermills is that the screen can receive a lot of wear and has a shortened life because of severe wear. Most of the wear occurs where the screen is adjacent the cutter bar. As the hammermill is rotating, it defines a generally cylindrical grinding zone. Anything that enters this cylindrical grinding zone will be struck by hammers of the hammermill and broken. The screen, which partially surrounds the hammermill, is curved, and forms an arc of a circle when viewed from the end, or in cross section. If the arc of the screen were completed it would form a cylinder around the hammermill. This hypothetical cylinder around the hammermill is termed the screen cylinder. The screen of the hammermill occupies part of the screen cylinder, but the rest of the screen cylinder is imaginary.

Another problem with prior art is that large debris can get past the cutter bar, but can cause damage as it travels around the screen. This can include debris like railroad spikes and other hard objects. A larger space behind the cutter bar allows such debris to accumulate there and thus reduces the damage and wear to the screen.

In the prior art, the screen cylinder and the screen are concentric around the cylindrical grinding zone of the hammermill. Since it is concentric, the gap between the screen and the cylindrical grinding zone is uniform across the surface of the screen. It is the same gap near the cutter bar, as it is at all parts of the screen.

A problem is that excessive wear occurs on the part of the screen that is adjacent to the cutter bar. An improved machine would solve this problem by positioning the screen so as to spread the wear out over a larger part of the screen, and not to concentrate the wear at the edge adjacent the cutter bar.

Additional objects, advantages and novel features of the invention will be set forth in part in the description which follows and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

These and other objects are accomplished by the hammermill of the invention with the screen configuration of the invention.

The invention is a screen configuration for a hammermill. The hammermill includes a cutter bar and a grinding mill. The grinding mill includes a mill shaft with hammers that attach to it. At the tip of the hammers are hammer tips, which are typically bolted in place. The mill shaft and its attached hammers are configured for rotation, and thus have an axis of rotation. The rotating mill shaft and hammers define a cylindrical grinding zone. The grinding mill also includes a cutter bar that is parallel to the axis of rotation of the hammermill. It is also adjacent to the cylindrical grinding zone. The hammers interact with the cutter bar by smashing objects between the hammer tips and the cutter bar, like the two cutting surfaces of a pair of scissors.

The grinding mill has an entry side from which product enters the hammermill. It also includes a curved screen, which forms an arc of a circle when viewed from the end or in cross section, which is positioned adjacent to the cylindrical grinding zone. The screen forms part of a screen cylinder, which is larger than the cylindrical grinding zone and which surrounds the cylindrical grinding zone. The screen has a screen axis, which is the same axis as the screen cylinder. After being struck by the hammers of the hammermill, product passes through the screen if it is small enough, which provides an exit route for ground material. The size of the holes on the screen determines the size of the product, which exits the hammermill. If material is too large to pass through the holes of the screen, it continues to be pounded by the hammermill until it is small enough to go through the hole.

The screen axis is parallel to the axis of rotation of the hammermill. In the prior art, the screen axis is on the same line as the axis of rotation. However, in the grinding mill of the invention, the screen axis is parallel, but offset from the axis of rotation of the hammermill.

In the present invention, the screen axis is positioned closer to the entry side than the axis of rotation. One configuration of the device can have the screen axis closer to the entry side as well as closer to the cutter bar. In a typical hammermill, the cutter bar is located at about a downward thirty-five degree angle from the axis of rotation. One preferred configuration of the invention is for the axis of the screen to be moved at the same angle towards the cutter bar.

In another embodiment of the invention, the axis of the screen is moved in the general direction of the entry side, but at an upward angle of approximately thirty degrees.

Each of these positions of the screen causes it to be non-concentric around the cylinder of the cylindrical grinding zone. Each of these positions also has the effect of lessening the amount of wear directly adjacent to the cutter bar, and extending the wear patterns over a larger surface area of the screen.

The purpose of the foregoing Abstract is to enable the United States Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive in nature.

### BRIEF DESCRIPTION OF THE DRAWINGS

FIG. 1 is a cross sectional view of a horizontal mill design of the invention.

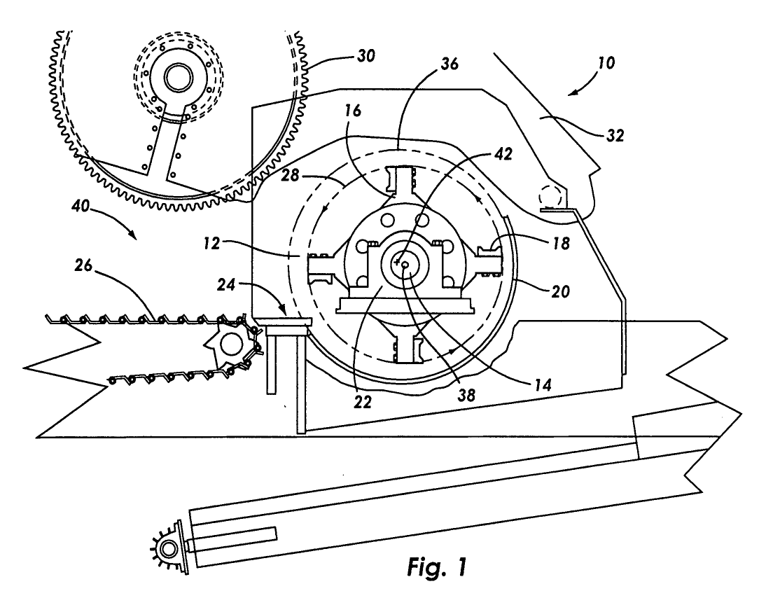

FIG. 2 is a cross sectional view of a tub grinder of the invention.

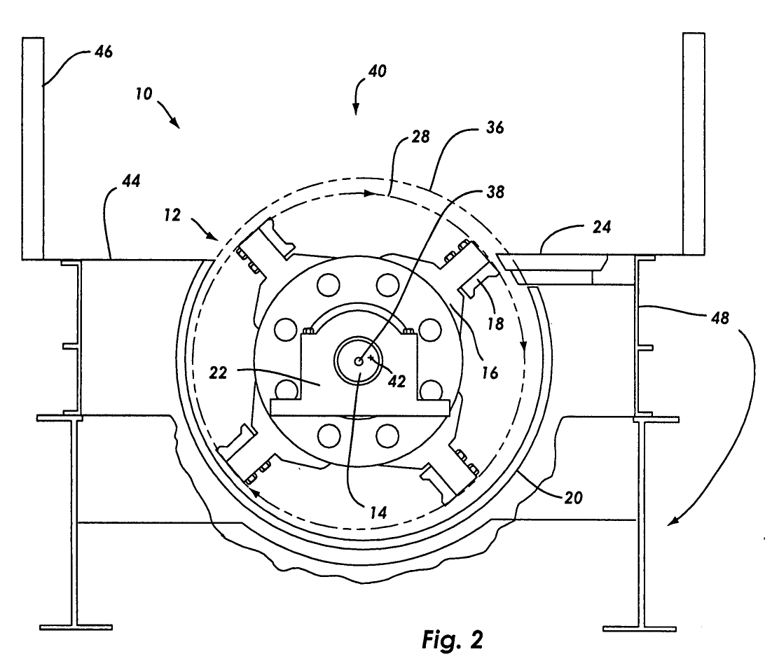

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed but, on the contrary, the invention is to cover all modifications, alternative constructions, and equivalents falling within the spirit and scope of the invention as defined in the claims.

Figures one and two show the hammermill design of the current invention. Figure one is a cross-sectional view showing a side view of a horizontal hammermill. The grinding device 10 includes a hammermill 12. The hammermill 12 is made up of a mill shaft 14, a number of hammers 16, with hammer tips 18 bolted to the ends of the hammers. The grinding device 10 also includes a screen 20, which is typically a steel screen with perforations of various sizes.

The hammermill 12 rotates around an axis of rotation 38. In rotating around the axis of rotation 38, the hammermill 12, with its hammer 16, forms a generally cylindrical grinding zone 28. While the hammermill is rotating, anything that enters the grinding zone 28 will be struck and pulverized.

The configuration of the hammermill of the invention can be utilized in hammermills of various sizes, so any particular dimensions given for a hammermill are not presented to restrict the scope of the invention. For purposes of illustration, a typical hammermill on which the configuration of the invention could be utilized would be a hammermill in which the mill shaft is approximately 112 inches long, and the cylindrical grinding zone is approximately 52 inches in diameter. Such a hammermill would weigh approximately 12,000 pounds, and rotate at 850 rpm's.

The hammermill includes a feed chain 26, which feeds material into the hammermill from an entry side 40. On the entry side 40 is a cutter bar 24. The cutter bar and the hammer tips work together to crush material like the two cutting pieces of scissors work together. The cutter bar is as wide as the hammermill, and typically 66 inches in length. The feed chain for the particular hammermill described above could be 66 inches wide, and would extend as far as necessary to the product loading area of the hammermill.

The hammermill includes a feed roller 30, which presses down against the feed chain 26, and traps material and helps feed it into the hammermill. The feed roller 30 is mounted in a grinder shroud 32, which raises and lowers with the feed roller. The feed roller typically has gripping teeth on it and uses its own weight or additional applied pressure to push down on the material on the feed chain.

Below the hammermill is a screen 20. For a hammermill as described above, the screen 20 would be made of 1 inch thick steel, and the hole size in the screen would vary depending on the desired product from the hammermill. The screen is forms an arc of a circle in cross section, and if extended around to form a complete circle, the screen will be part of the circle. This hypothetical circle is termed the screen cylinder, for purposes of illustration. The screen occupies part of the screen cylinder. The screen is curved so that it can be rotated out of its position in the hammermill for replacement and repair. The screen cylinder has a screen axis, which is the axis line of the screen cylinder.

In the prior art, the screen axis 42 is on the same line as the axis of rotation 38. However in the invention, the screen axis is moved towards the entry side 40. It can also be moved towards the entry side 40 and also towards the cutter bar 24. Another preferred embodiment of the screen access position is to be moved towards the entry side 40 and upward from the cutter bar 24. In the mill shown in figure one, the cutter bar is approximately at a thirty degree angle below horizontal. A preferred embodiment of the invention is for the screen axis 42 to be located one half an inch towards the entry side 40, and one half an inch at a thirty degree angle above the horizontal from the axis of rotation. This causes the screen cylinder to be non-concentric around the grinding zone, and to have a larger separation between the grinding zone and the screen adjacent the cutter bar. This causes the impact wear on the screen to be spread out over a larger area of the screen and causes the screen to last longer before repairs or replacement are necessary.

Figure two shows a grinding device of the current invention mounted in a tub grinder. A tub grinder is a grinder that contains a grinder floor with sidewalls. A hole in the floor of the tub grinder is present, and part of the grinding zone extends through the floor of the tub and into the tub. As material is pushed across the floor of the hammermill, it encounters the grinding zone, and is partially ground away. As it completes another rotation around the floor of the tub, another part of the material is ground away, until all of it is ground away. As with the horizontal grinder, the screen cylinder 36 is positioned so it is not concentric with the grinding zone. The screen axis 42 is moved so that it is closer to the entry side 40. One configuration of the invention would have the screen axis moved toward the cutter bar about one half an inch.

While there is shown and described the present preferred embodiment of the invention, it is to be distinctly understood that this invention is not limited thereto but may be variously embodied to practice within the scope of the following claims. From the foregoing description, it will be apparent that various changes may be made without departing from the spirit and scope of the invention as defined by the following claims.

1. In a device for grinding material using a hammermill and a cutter bar, a grinding mill comprising:
a mill shaft with attached hammers, configured for rotation about an axis of rotation, and defining a cylindrical grinding zone, with said cutter bar parallel to said axis of rotation and adjacent to said cylindrical grinding zone;
said grinding mill having an entry side, with product entering said cylindrical grinding zone from said entry side;
a curved screen positioned adjacent to said cylindrical grinding zone, said screen forming an arc of a circle in cross section and forming part of a screen cylinder larger than the cylindrical grinding zone, said screen having a screen axis, and said screen defining a product exit route for ground material;
wherein said screen axis is parallel to said axis of rotation, and said screen axis is positioned closer to said entry side of said cylindrical grinding zone than said axis of rotation, so that there is more clearance between said screen cylinder and said cylindrical grinding zone at said entry side than at other sides of said grinding mill.

2. The grinding mill of claim 1 in which the screen axis is positioned relative to said axis of rotation so that maximal clearance between said screen and said cylindrical zone of grinding is adjacent to said cutter bar.

3. In a device for grinding material using a hammermill and a cutter bar, a grinding mill comprising:
a mill shaft with attached hammers, configured for rotation about an axis of rotation, and defining a cylindrical grinding zone, with said cutter bar parallel to said axis of rotation and adjacent to said cylindrical grinding zone;
said grinding mill having an entry side, with product entering said cylindrical grinding zone from said entry side;
a curved screen positioned adjacent to said cylindrical grinding zone, said screen forming an arc of a circle in cross section and forming part of a screen cylinder larger than the cylindrical grinding zone, said screen having a screen axis, and said screen defining a product exit route for ground material;
wherein said screen axis is parallel to said axis of rotation, and said screen axis is positioned closer to said cutter bar than said axis of rotation, so that there is more clearance between said screen cylinder and said cylindrical grinding zone adjacent said cutter bar than at other positions around the cylindrical grinding zone.

4. In a device for grinding material using a hammermill and a cutter bar, and having a tub with a tub floor and tub sides, and an opening in said tub floor for said hammermill, a grinding mill comprising:
a mill shaft with attached hammers mounted below a floor of a tub grinder, configured for rotation about an axis of rotation, and defining a cylindrical grinding zone, with said cutter bar parallel to said axis of rotation and adjacent to said cylindrical grinding zone, and positioned adjacent to a tub floor;
said grinding mill having an entry side, with product entering said cylindrical grinding zone from said entry side within said tub;
a curved screen positioned adjacent to said cylindrical grinding zone, said screen forming an arc of a circle in cross section and forming part of a screen cylinder larger than the cylindrical grinding zone, said screen having a screen axis, and said screen defining a product exit route for ground material;
in which said screen axis is parallel to said axis of rotation, and said screen axis is positioned closer to said cutter bar than said axis of rotation, so that there is more clearance between said screen cylinder and said cylindrical grinding zone adjacent said cutter bar than at other positions around the cylindrical grinding zone.

5. In a device for grinding material using a hammermill and a cutter bar, and having a feed roller and a feed chain, a grinding mill comprising:
a mill shaft with attached hammers mounted adjacent said feed chain, configured for rotation about an axis of rotation, and defining a cylindrical grinding zone, with said cutter bar parallel to said axis of rotation and adjacent to said cylindrical grinding zone, and positioned adjacent to said feed chain;
said grinding mill having an entry side, with product entering said cylindrical grinding zone from said entry side on said feed chain;
a curved screen positioned adjacent to said cylindrical grinding zone, said screen forming an arc of a circle in cross section and forming part of a screen cylinder larger than the cylindrical grinding zone, said screen having a screen axis, and said screen defining a product exit route for ground material;
in which said screen axis is parallel to said axis of rotation, and said screen axis is positioned closer to said cutter bar than said axis of rotation, so that there is more clearance between said screen cylinder and said cylindrical grinding zone adjacent said cutter bar than at other positions around the cylindrical grinding zone.
